(19) United States
(12) Patent Application Publication
(10) Pub. No.: US 2020/0356998 A1
(43) Pub. Date: Nov. 12, 2020

(54) APP-INITIATED VOICE TRANSACTION

(71) Applicant: salesforce.com, inc., San Francisco, CA (US)

(72) Inventors: Prabhjot SINGH, Union City, CA (US); Tarundeep BATRA, Fremont, CA (US)

(21) Appl. No.: 16/408,141

(22) Filed: May 9, 2019

(51) Int. Cl. G06Q 20/40; H04L 29/06

(52) U.S. Cl. CPC G06Q 20/40145; H04L 63/029; H04L 63/0861

(57) ABSTRACT

In an enterprise computing platform, a voice transaction application enables a customer to transact business with electronic commerce vendors using a voice-initiated transaction. A transaction can be authorized using the voice transaction application to initiate transactions with the vendor. A voice transaction gateway provides an interface between the vendor and a gateway to further authorize the transaction, including authenticating the transaction using a voice imprint of the customer's voice. Authorization of the transaction, including authentication and approval of the transaction, is accomplished without requiring the customer to disclose financial and other sensitive information to the vendor. The vendor benefits from not having to risk liability associated with obtaining sensitive information from the customer. Customers can use the voice transaction application to pre-register with a voice transaction gateway using their phone number (PH #) to establish an account for authenticating their transactions.

### TECHNICAL FIELD

Embodiments of the invention relate generally to the field of electronic commerce systems, and more particularly, to transaction gateways for processing electronic commerce transactions.

### BACKGROUND

Application service providers that support electronic commerce typically use payment gateways to enable vendors, such as retailers or merchants, and their customers transact business. A gateway, such as a payment gateway, enables the transfer of information between the vendor and the customer's and vendor's banks to authorize and settle financial transactions.

To initiate a transaction using a payment gateway a website or customer service agent of a retailer typically requires that the customer provide sensitive financial account information which the retailer then relays to the payment gateway. For example, when a customer uses a credit card, the customer provides the credit card number and the card verification value (CVV) number to a website or to the customer service agent during a telephone call or at a point-of-sale (POS) location. This sensitive information is entered into the retailer's order system and forwarded to the payment gateway. The payment gateway notifies the retailer whether the payment was successful, and the customer and retailer complete the transaction.

### BRIEF DESCRIPTION OF THE DRAWINGS

The included drawings, by way of example only and not limitation, illustrate possible structures and operations for implementing the disclosed inventive systems, apparatus, methods, and computer-readable storage media. The drawings do not limit any changes in form and detail that may be made by one skilled in the art consistent with the spirit and scope of the disclosed implementations.

FIGS. 1A-1B are block diagrams illustrating an overview of an architecture for a voice transaction gateway in an enterprise computing platform according to one embodiment;

FIG. 2 is a block diagram of a voice transaction gateway registrar for a voice transaction gateway in enterprise computing platform according to one embodiment;

FIG. 3 is a flow diagram of processes for implementing a voice transaction gateway in enterprise computing platform according to one embodiment;

FIGS. 4A-4C are flow diagrams of processes for implementing a voice transaction gateway in enterprise computing platform according to one embodiment;

FIG. 5 is a flow diagram of processes for implementing a voice transaction gateway in enterprise computing platform according to one embodiment;

FIGS. 6A-6B are block diagrams illustrating an overview of a cloud computing environment within which one or more implementations of a voice transaction gateway of an enterprise computing platform can be carried out; and

FIG. 7 is a block diagram illustrating a machine in the exemplary form of a general computer system within which one or more implementations of a voice transaction gateway of an enterprise computing platform can be carried out.

### DETAILED DESCRIPTION

Revealing financial account information as well as other sensitive information, such as residence and telephone number, to a customer service agent or online can jeopardize the security of a customer's account and his or her privacy. Although some payment gateways have automated the process for vendors and customers, such as PayPal, they still require the customer to provide sensitive information, such as credit card information and the CVV numbers as part of the process for authenticating and authorizing payment for a financial transaction.

To minimize the risk to the security of the customer's account and his or her privacy, embodiments of a voice transaction gateway provides an architecture for application service providers to exploit the use of voice imprint technology, also referred to as voice fingerprinting, or voice signatures, to authenticate transactions before they are processed by a gateway for authorization of payment for or access to the vendor's goods and services.

In one embodiment, instead of requiring customers to provide sensitive account information, vendors and their customers can use a voice transaction gateway integrated with a gateway, such as a payment gateway or other type of gateway (subscription-based, etc.), to facilitate authentication of the transaction using the customer's PH # and voice.

In one embodiment the voice transaction gateway includes a voice transaction registrar to register a customer profile for a customer, including an account number, one or more payment methods, the customer's PH # and a voice signature representing a unique biometric marker identifying the customer by their voice as captured during a telephone call or other type of voice communication. In addition, the customer can register secondary PH # s for family members and others for whom the customer can authorize transactions.

In one embodiment, registered customers of the voice transaction gateway can transact business with vendors using their registered PH # and their voice to authenticate their transactions. The voice transaction gateway can then submit the authenticated transaction to a gateway, such as a payment gateway, for authorizing payment for or access to requested goods and services.

In one embodiment, the registered PH # is a first authentication factor and the customer's voice is a second authentication factor. The voice transaction gateway authenticates transaction requests using the first and second authentication factors in accordance with multi-factor authentication algorithms. For example, the first authentication factor can be confirmed when a call to the registered PH # is answered. The second authentication factor can be confirmed when a voice imprint of the answering voice matches the unique voice fingerprint/signature registered for a customer.

In one embodiment, to further facilitate authentication of the transaction using the customer's PH # and voice, the voice transaction gateway can analyze a sentiment of the customer's voice to approve or disapprove a transaction request otherwise authenticated based on the first and second authentication factors. For example, the voice transaction gateway can analyze whether the customer voiced a “YES” or a “NO” when answering the voice transaction gateway call to confirm a transaction request.

In one embodiment, the voice transaction gateway can be integrated with a gateway, such as a payment gateway, capable of authorizing or not authorizing a transaction authenticated by the voice transaction gateway.

In one embodiment, customers can use a voice transaction app to initiate voice transactions using the voice transaction gateway. The voice transaction app can provide an additional level of authentication through a login process. For example, a successful login to the voice transaction app can add to and/or substitute for the first authentication factor in the authentication of a voice transaction initiated via the app.

In this manner, the voice transaction gateway provides an architecture for application service providers to exploit the use of voice fingerprinting/signatures to enable vendors to conduct business without risking liability for unauthorized use of the customer's sensitive information. Likewise, customers can conduct business without jeopardizing exposure of their sensitive information to vendors that might not have adequate security measures in place to safeguard sensitive information against misuse.

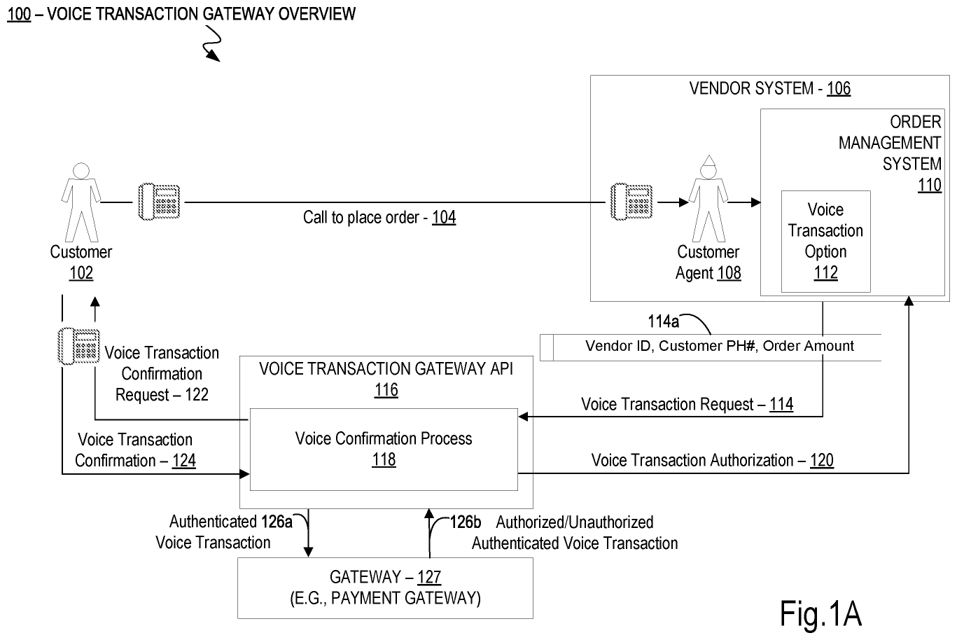

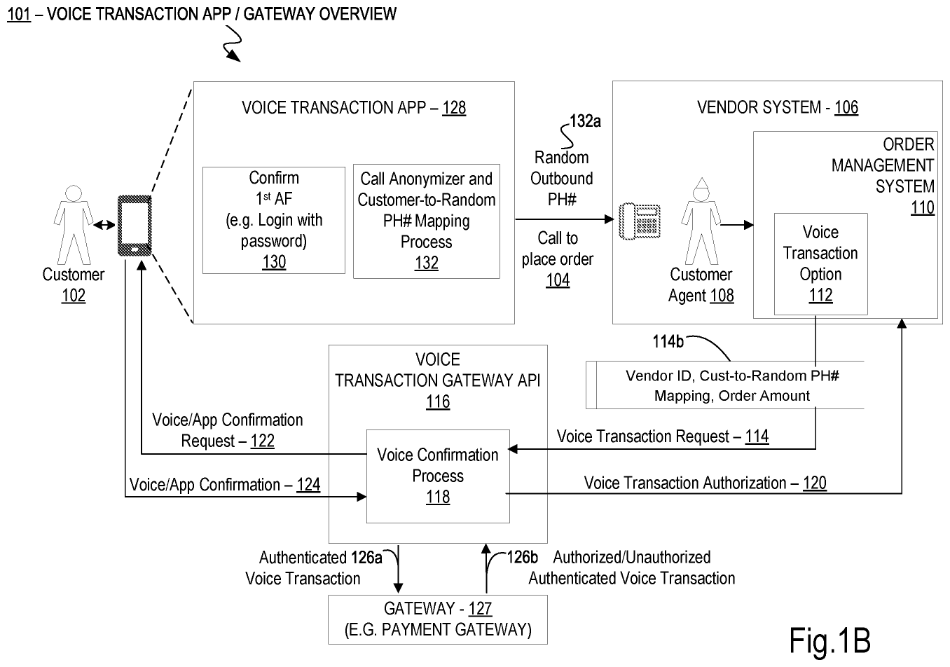

FIGS. 1A-1B are block diagrams illustrating an overview of an architecture 100 for a voice transaction gateway 116 in an enterprise computing platform according to one embodiment. The enterprise computing platform includes an application service provider's vendor system 106 that provides, among other services, an order management system 110 for a retailer's customer agent 108 to enter orders transacted using a gateway 127, such as a payment gateway, integrated with a voice transaction gateway 116. In one embodiment, the order management system 110 is configured with a voice transaction option 112 that generates a voice transaction request 114 to an application programming interface (API) of the voice transaction gateway 116 operating on the enterprise computing platform.

In one embodiment, a customer 102 visits or initiates a telephone call to place an order 104 with a retailer, such as a fast-food restaurant. The retailer customer agent 108 takes the order 104 from the customer and enters the information into the order management system 110. Alternatively, the customer can enter the information using a self-service feature of the order management system 110. The customer 102 is offered the use of the voice transaction option 112. Instead of taking sensitive information from the customer to complete the order, such as financial information (credit card, debit card numbers and the like) or other personal information, the customer agent 108 (or self-service customer) invokes the voice transaction option 112. In one embodiment, the voice transaction option 112 generates a voice transaction request 114 that includes the vendor ID, customer's PH # and a dollar amount 114a associated with the request. In one embodiment, the voice transaction request 114 can include other information 114a that the customer can pre-register for use with the voice transaction option 112, such as residence information for delivery and so forth. The voice transaction request 114 is transmitted to the voice transaction gateway API 116 whereupon a voice confirmation process 118 authenticates the voice transaction request 114 using the customer's PH # and a voice imprint captured from the customer as part of the voice confirmation process.

For example, in one embodiment, the voice confirmation process 118 generates a voice transaction confirmation request 122 by initiating a voice call to the customer 102 using the customer's PH #114a included in the voice transaction request 114. The successful completion of the voice call to the customer 102, along with the capture of the customer's voice imprint during the voice call, functions as the respective first and second authentication factors returned to the voice confirmation process 118 in voice transaction confirmation 124. Now authenticated, the voice transaction request 114 is ready for processing by a gateway 127, such as a payment gateway.

For example, in one embodiment, after authenticating the voice transaction request 114 using the first and second authentication factors (as part of a multi-factor authentication algorithm), the voice confirmation process 118 sends an authenticated voice transaction 126a to the gateway 127 for authorization, such as authorization for payment (e.g., for goods or services) or authorization for access (e.g., for content delivery). Upon processing by the gateway 127, the voice confirmation process 118 receives the return of an authenticated voice transaction 126b that has either been authorized or not authorized.

For example, in one embodiment, a customer's authenticated voice transaction 126a can still be rejected by a payment gateway 127 if authorization for payment is declined due to the customer's credit limit having been reached or for insufficient funds, or for other reasons that a payment gateway uses to reject a transaction. The rejection can result in an authenticated but unauthorized voice transaction 126b. On the other hand, if the payment gateway 127 authorization for payment is successful, then the customer's authenticated voice transaction 126a results in an authenticated and authorized voice transaction 126b. The voice confirmation process 118 transmits to the order management system 110 a voice transaction authorization notification 120 to notify the customer agent 108 (or self-serve customer) that the payment for the order has been any of authorized or not authorized depending on the voice transaction result 126b.

FIG. 1B illustrates an overview of an architecture 101 for a voice transaction gateway 116 using a voice transaction app 128 in an enterprise computing platform according to one embodiment. In one embodiment, the voice transaction app 128 can be an application operating on a customer's device, such as a computer or mobile device, that allows a customer 102 that has pre-registered with the voice transaction gateway 116 to initiate a voice transaction with the vendor system 106 using their device. In one embodiment, the voice transaction app 128 includes a process to confirm a first authentication factor 130 for authenticating the voice transaction even before the order is placed with the order management system 110. For example, the voice transaction app 128 can confirm the first authentication factor 130 based on the interaction of the customer 102 with the app 128, such as entering information known only to the customer, including a password, or other security information as part of a login process.

In one embodiment, once the first authentication factor 130 has been confirmed, the voice transaction app 128 prepares to call the customer agent 108 of the vendor system 106 by optionally executing a call anonymizer and customer-to-Random PH # mapping process 132 which uses a random dialer to initiate the call to place the order 104. The customer's PH # is thereby masked from view of the customer agent 108. Since the customer 102 is pre-registered with the voice transaction gateway 116, the voice transaction option 112 can automatically be activated after the customer agent 108 takes the order and enters the order (or the customer enters the order using a self-service feature of the order system).

Upon activation of the voice transaction option 112, the vendor system adds the amount charged for the order into the order management system 110 and generates a voice transaction request 114 that includes the order amount and, optionally, the Customer-to-Random PH # mapping 132 as part 114b of the request 114. Other information 114b provided by the customer can be included in the request 114 as well, such as delivery information and the like. The voice confirmation process 118 generates a voice/app confirmation request 122 like the voice transaction confirmation request 122 in FIG. 1A, but this time interacting directly with the customer 102 via the voice transaction app 128 on the customer's device to authenticate the voice transaction request 114.

For example, because the customer 102 has already activated the voice transaction app 128 on their device, the voice transaction request 114 is already partly authenticated by confirmation of the first authentication factor in the voice transaction app. The voice confirmation process 118 completes the authentication of the voice transaction request 114 by obtaining the voice imprint of the customer's voiced response using an existing connection to the customer 102 via the voice transaction app 128 to confirm the voice transaction request 114. Alternatively, the voice confirmation process 118 obtains confirmation of the voice transaction request using other means, such as a response to a text message sent to the customer's device in which the voice transaction app 128 is installed.

In one embodiment, it can be necessary to initiate a separate voice call to a primary person to authenticate voice transaction requests 114 initiated by a customer 102 registered to the primary person's customer profile as a secondary customer. For example, if the customer that initiated the voice transaction request 114 is a child (secondary) whose parent (primary) is responsible for authenticating the voice transaction request 114, then the voice confirmation process 118 initiates the separate voice call to the primary customer's registered PH # as the first authentication factor and obtains the voice imprint of the primary customer's voiced response as the second authentication factor.

In one embodiment, after using the first and second authentication factors (as part of a multi-factor authentication algorithm) to authenticate the voice transaction request 114, the voice confirmation process 118 sends an authenticated voice transaction 126a to the gateway 127 for authorization, such as authorization for payment (e.g., for goods or services) or authorization for access (e.g., for subscription-based content delivery). Upon processing by the gateway 127, the voice confirmation process 118 receives the return of an authenticated voice transaction 126b that has either been authorized or not authorized.

For example, in one embodiment, a customer's authenticated voice transaction 126a can still be rejected by a payment gateway 127 if authorization for payment is declined due to the customer's credit limit having been reached or for insufficient funds, or for other reasons that a payment gateway can use to reject a transaction (e.g., flagged as stolen card). The rejection can result in an authenticated but unauthorized voice transaction 126b. On the other hand, if the payment gateway 127 authorization for payment is successful, then the customer's authenticated voice transaction 126a results in an authenticated and authorized voice transaction 126b. The voice confirmation process 118 transmits to the vendor system 106 (e.g., the order management system 110) a voice transaction authorization notification 120 to notify the customer agent 108 and customer 102 that the payment for the order has been any of authorized or not authorized depending on the result 126b.

In one embodiment the enterprise computing platform in which embodiments of the voice transaction gateway 116 using architectures 100/101 can be implemented includes application servers and databases of the vendor system 106, voice transaction gateway 116 and transaction gateway 127 connected via a network (not shown). During operation, different combinations of application servers and data servers can execute the vendor system 106, voice transaction gateway 116 and transaction gateway 127 and access data stored in the databases.

In one example, enterprise computing platform in which the vendor system 106 operates can be a multi-tenant system (MTS). A multi-tenant system refers to a database system such as vendor system 106 where different hardware and software can be shared by one or more vendors (or other organizations/businesses) represented as tenants. For example, enterprise computing platform can associate a first tenant with an organization that sells airline services, associate a second tenant with an organization that sells pizzas, and associate a third tenant with an organization that sells office supplies and equipment. The multi-tenant system can effectively operate as multiple virtual databases each associated with one of tenants.

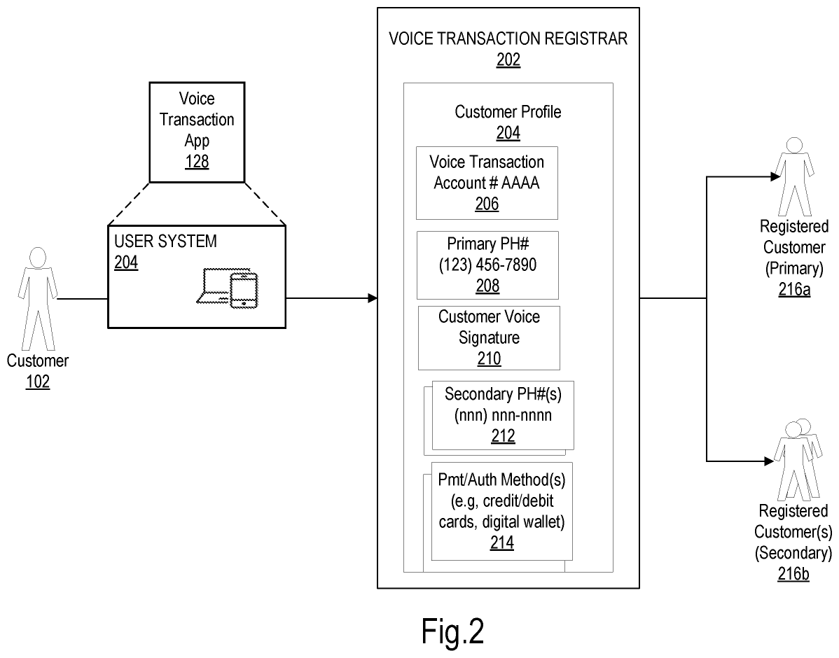

FIG. 2 illustrates additional details of a voice transaction gateway 116 as described in FIGS. 1A-1B. In one embodiment a customer 102 interacts with a user system 204 configured to operate a voice transaction app 128 in connection with a voice transaction registrar 202. By way of example only and not limitation, the voice transaction registrar 202 maintains for each customer a customer profile 204, including a voice transaction account number 206 uniquely associated with the customer 102, along with the customer's primary PH #208, e.g., (123) 456-7890, a customer voice signature 210 representing a biometric of the customer's voice, any secondary PH # s to associate with the customer's account 206, such as family member PH # s for whom the customer is responsible for authenticating and approving voice transaction requests against account 206, and one or more payment/authorization methods 214 associated with account 206, such as credit cards, debit cards and the like. In one embodiment, the one or more payment/authorization methods 214 can include a digital wallet that the customer uses to maintain their payment methods. Once the customer 102 has registered their customer profile 204 with the voice transaction registrar 202, they are considered a registered customer, either primary 216a or one or more secondary customers 216b, all of whom can use the voice transaction option 112 described as in FIGS. 1A-1B. However, only the primary registered customer 216a (e.g. the parent) can use their voice to authenticate voice transaction requests initiated by themselves or the secondary registered customers 216b (e.g. the children) associated with the customer profile 204.

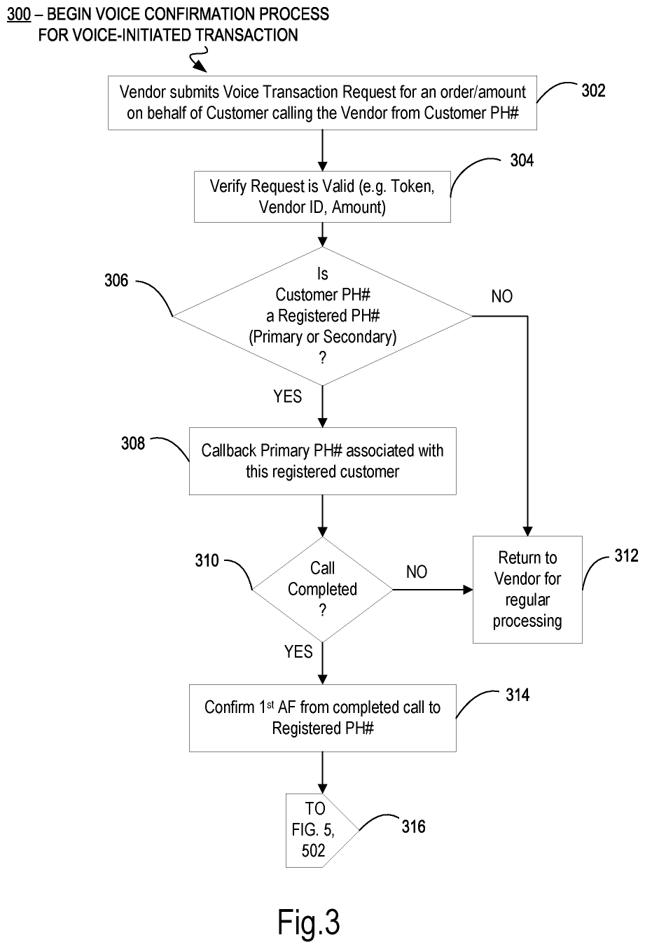

FIG. 3 is a flow diagram of processes for implementing a voice transaction gateway in enterprise computing platform according to one embodiment. At 302, a vendor submits to the voice transaction gateway API a voice transaction request for an order. In one embodiment, the voice transaction request includes the vendor's identification (vendor ID) and an amount the vendor computed for the order. The voice transaction request also includes the customer PH #.

In one embodiment, at 304 the voice transaction gateway verifies that the request is valid based on a token passed from the vendor, the vendor ID and the amount. At 306, the voice transaction gateway determines whether the customer PH # included in the request is, in fact, registered for a primary or secondary customer(s) based on the customer profile associated with the customer PH #. If not, at 312, the voice transaction gateway rejects the request and returns control to the vendor for a regular payment process since the customer has not registered and is ineligible to use the voice transaction option 112 of the vendor system 106 (e.g., the order management system 110).

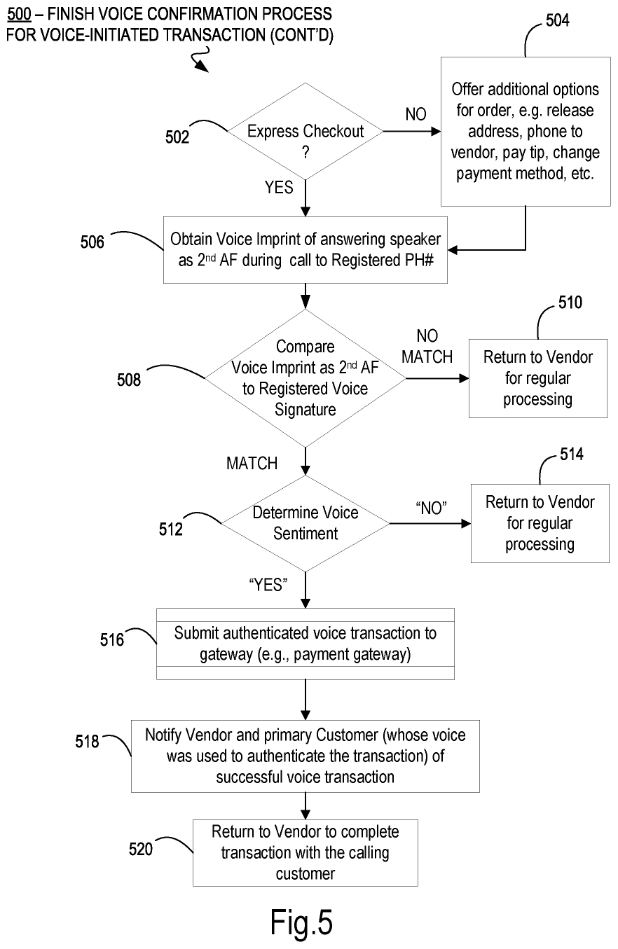

In one embodiment, if there is a registered Customer PH # that can be used to perform the voice confirmation process, where the Customer PH # is registered to a primary customer, then at 308 the voice transaction gateway initiates a callback to the Customer PH # to begin the voice confirmation process. If, at 310, the call is successfully completed (i.e., if the customer answers the call) then the voice transaction gateway at 314 confirms the first authentication factor used to authenticate the voice transaction request. At 316 the voice transaction gateway continues the voice confirmation process (at FIG. 5, 502). If, however, the call is not successfully completed (i.e. no answer) then the voice transaction gateway at 312 returns to the vendor for regular processing since the voice confirmation process cannot be performed.

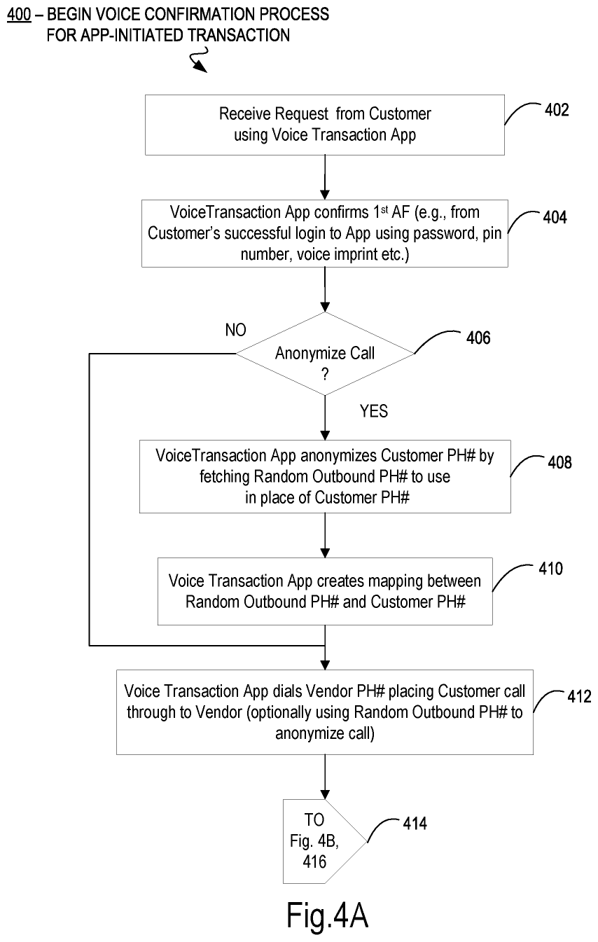

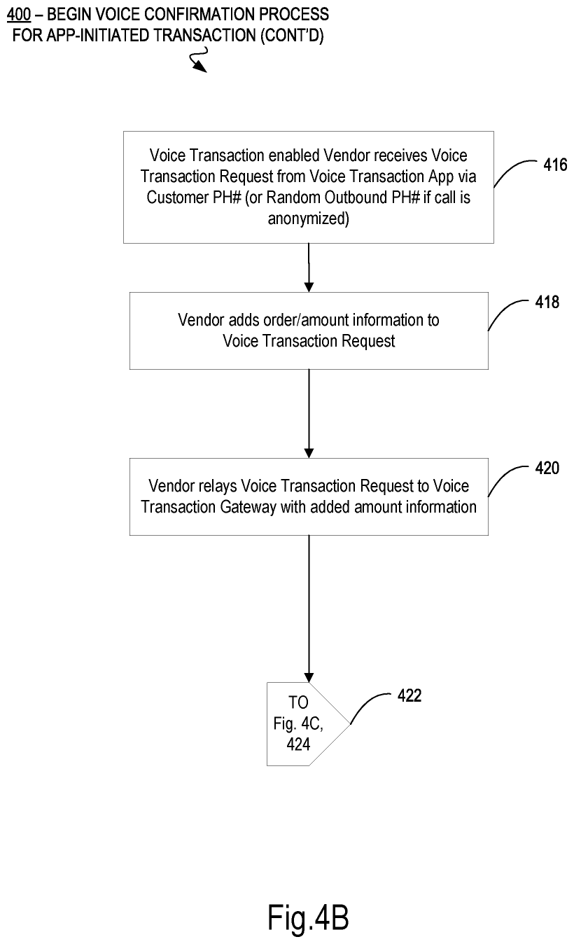

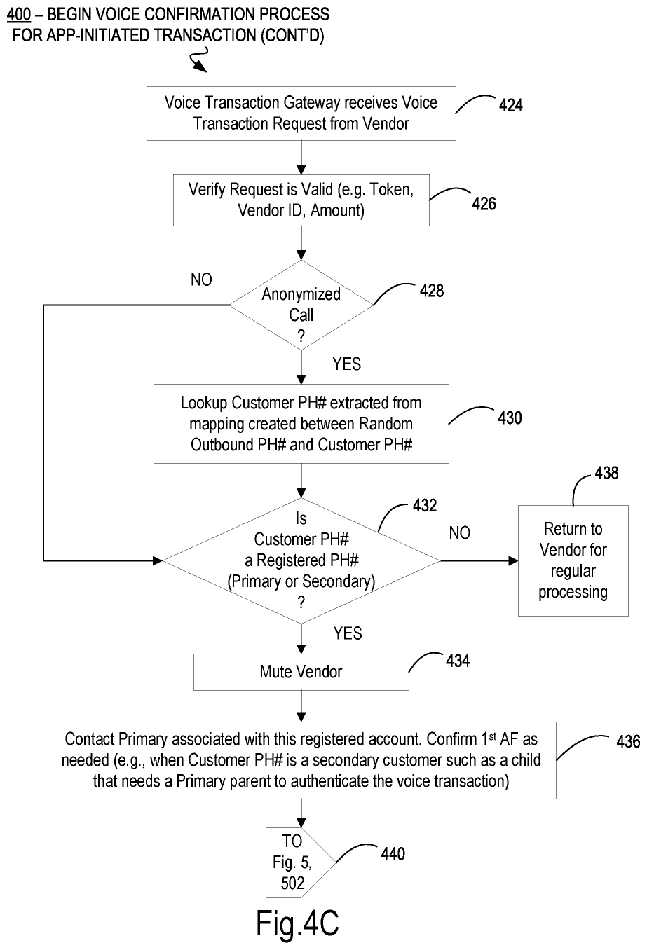

FIGS. 4A-4C are flow diagrams of processes for implementing a voice transaction gateway for an app-initiated voice transaction in enterprise computing platform according to one embodiment. At 402 the voice transaction app installed on a customer's device receives a request from the customer to initiate a voice transaction with a vendor. At 404 the voice transaction app confirms a first authentication factor from a successful interaction with the customer, such as a successful login to the app using information known to the customer, such as a password or the like, or even using information unique to the customer, such a biometric marker of the customer's finger or voice. Of course, if the customer has not yet registered with the voice transaction gateway, the customer will first be prompted to register and create a customer profile (as described with reference to FIG. 2).

In one embodiment, at 406, the voice transaction app determines whether to optionally anonymize the customer PH # before initiating the voice transaction with the vendor. For example, in one embodiment, at 408 the voice transaction app fetches a random output PH # to use in place of the customer PH # when calling the vendor. At 410, to ensure that the customer's PH # remains private but is still passed through to the voice transaction gateway, the voice transaction app creates a mapping between the random outbound PH # and the customer PH #. At 412 the voice transaction app is now ready to dial the vendor PH # to place the customer's call using the Customer PH # (or the random outbound PH # if anonymized), and additional processing 414 continues in FIG. 4B at 416.

FIG. 4B illustrates processes at the vendor beginning at 416 when a voice transaction-enabled vendor receives a voice transaction request from the voice transaction app via the Customer's PH # (or the random output PH # if anonymized). The voice transaction request includes the mapping (if anonymized, created at 410) between the random outbound PH # and the Customer PH #. At 418, the vendor adds the order amount information as needed to the voice transaction request. At 420 the vendor then relays the voice transaction request to the voice transaction gateway with the added amount information and, if anonymized, passes through the mapping (created at 410) between the random output PH # and the Customer PH #. At this point the customer's personal information, including his or her Customer PH # remains shielded from the vendor and processing continues 422 at FIG. 4C, 424.

FIG. 4C illustrates processes at the voice transaction gateway beginning at 424 to receive the voice transaction request relayed by the vendor on behalf of the customer. At 426, the voice transaction gateway verifies whether the request is valid, such as verifying the token, vendor ID and the amount. At 428, the voice transaction gateway determines whether the call to the vendor in which the voice transaction request was received has been anonymized. If so, at 430, the voice transaction gateway extracts the customer PH # from the mapping (created at 410) between the random outbound PH # and the Customer PH #. The voice transaction gateway uses the Customer PH # to perform a lookup of the Customer PH # against a database of registered Customer PH # s.

In one embodiment, at 432, the voice transaction gateway determines whether the customer PH # is, in fact, a registered PH # (primary or secondary) based on the customer profile associated with the customer PH # and stored in a database of registered Customer PH # s. If not, then at 438, the voice transaction gateway rejects the voice transaction request and returns control to the vendor for regular payment processing since the customer either has not registered or the registration is no longer valid, and the customer is ineligible to use the voice transaction option of the vendor's order management system. For voice transactions initiated through the voice transaction app, most customers will ordinarily be currently registered.

In one embodiment, if the Customer PH # is determined to be a registered PH #, whether registered to a primary customer or to a secondary customer, then at 434 the voice transaction gateway continues by muting the vendor to ensure that the customer's privacy is protected against exposure of sensitive information to the vendor and/or vendor's customer agent during the remainder of the voice confirmation process of authenticating and approving the voice transaction request. Once muted, at 436 the voice transaction gateway proceeds to contact the primary customer associated with the registered account via the primary's Customer PH #.

In one embodiment, if the Customer PH # is associated with a secondary customer (e.g., a child), then the voice transaction gateway first determines the primary customer responsible for confirming requests made by the secondary customer (e.g., the parent responsible for confirming requests made by the child). The voice transaction gateway then initiates a call to the Customer PH # registered for the primary customer. In one embodiment, after establishing a voice connection with the primary's Customer PH # on behalf of a secondary customer's request, the voice transaction gateway proceeds to confirm the primary's Customer PH # as an additional authentication factor based on a completed call to the primary's Customer PH # since the first authentication factor confirmed at 404 was based only on successful login to the voice transaction app by a secondary customer (e.g., the child). Processing continues 440 at FIG. 5, 502.

In one embodiment, if the Customer PH # included in the voice transaction request is registered to the primary customer, then the voice connection with the primary is already established and the first authentication factor confirmed at 404 is acceptable since it was based on successful login to the voice transaction app by the primary customer (e.g., a parent or other primary customer capable of authenticating voice transaction requests. Processing continues 440 at FIG. 5, 502.

FIG. 5 is a flow diagram of processes for implementing a voice transaction gateway in enterprise computing platform according to one embodiment. At 502, the voice transaction gateway concludes the voice confirmation processes begun in FIG. 3 or FIGS. 4A-4C, by optionally offering to the customer at 502 an express checkout option or the additional options at 504, such as to release his or her address and PH # to the vendor, to pay a tip or to change the payment method for the voice transaction before the voice transaction gateway relays the request to a payment gateway. Since the voice connection at this point is audible only to the customer and the voice transaction gateway the customer's privacy and security in sensitive information is maintained.

In one embodiment, at 506, the voice transaction gateway proceeds to obtain a voice imprint of the answering speaker (i.e., the purported primary customer) during the separate call to the primary customer or during the voice connection already established via the voice transaction app. The voice imprint functions as the second authentication factor. At 508, the voice transaction gateway compares the voice imprint from 506 to the voice signature that the primary customer registered with the voice transaction gateway registrar (FIG. 2). If there is no match, then at 510, the voice transaction gateway rejects the voice transaction request and returns control to the vendor for regular processing. If, however, there is a match, the voice transaction gateway proceeds, at 512, to determine whether the voice sentiment of the matching voice imprint expresses a sentiment of “YES” to approve the voice transaction request or a sentiment of “NO” to disapprove the voice transaction request.

In one embodiment, at process 514, if the sentiment of “NO” was received, the voice transaction gateway rejects the voice transaction request and returns control to the vendor for regular processing. If, however, the sentiment of “YES” was received, the voice transaction gateway proceeds at 516 to submit the voice transaction request to a gateway integrated with the voice transaction gateway to carry out the transaction details. For example, if the gateway is a payment gateway, the gateway carries out the task of verifying the funds available through a payment method selected by the customer, crediting the vendor account, debiting the customer account and so forth. Finally, at 518 the voice transaction gateway generates a voice transaction notification to transmit to the vendor and the customer's registered PH # to alert them to the completed voice transaction request, and lastly, at 520, the voice transaction gateway returns control to the vendor to complete the transaction with the customer. In this manner, the voice confirmation process (FIG. 1A-1B, 118) manages the authentication and approval of a voice transaction request (FIG. 1A-1B, 114) such that the gateway (FIG. 1A-1B, 127) need only authorize or not authorize the voice transaction and carry out any settlement processes associated with the voice transaction.

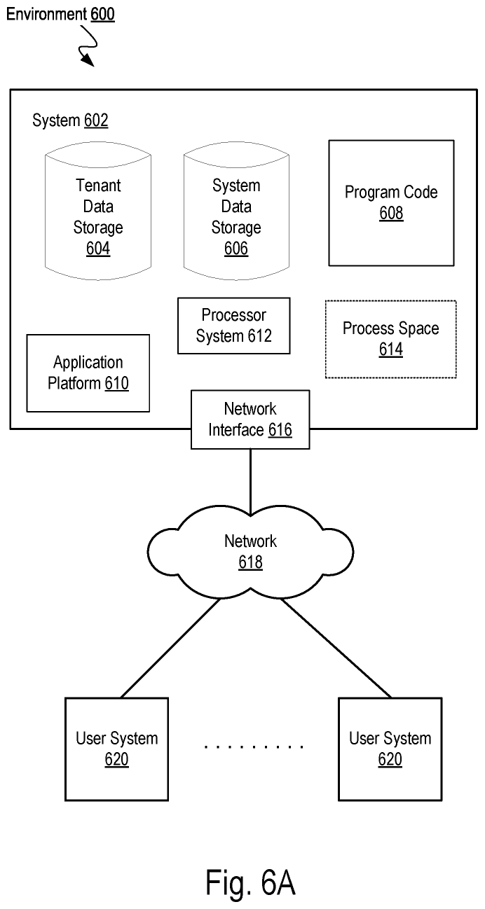

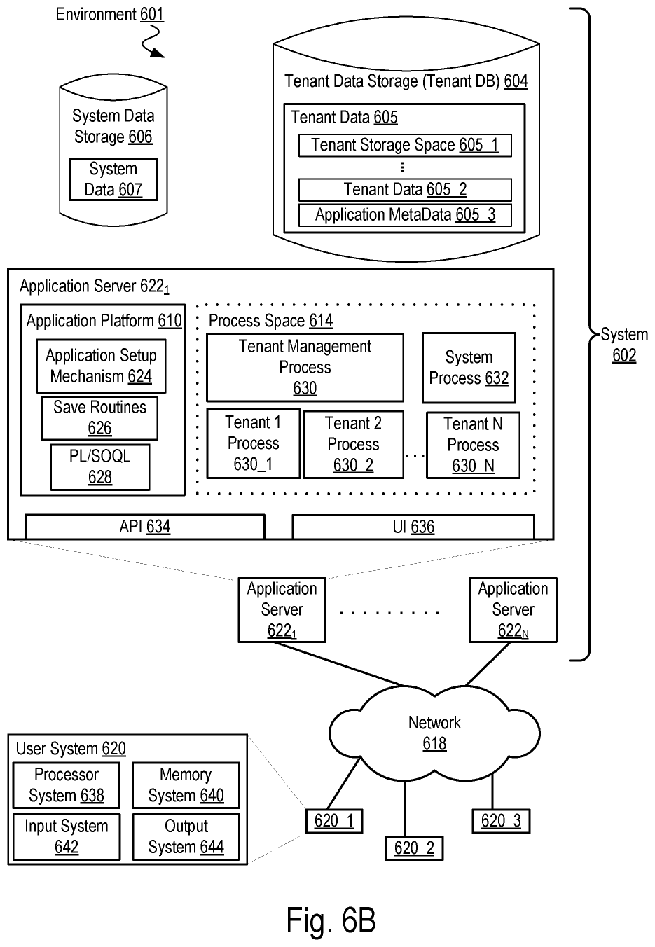

FIG. 6A illustrates a block diagram of an environment 600 in which an on-demand database service that supports a voice transaction gateway API can be implemented in accordance with the described embodiments. Environment 600 may include user systems 620, network 618, system 602, processor system 612, application platform 610, network interface 616, tenant data storage 604, system data storage 606, program code 608, and process space 614. In other embodiments, environment 600 may not have all the components listed and/or may have other elements instead of, or in addition to, those listed above.

Environment 600 is an environment in which an on-demand database service exists. User system 620 may be any machine or system that is used by a user to access a database user system. For example, any of user systems 620 can be a handheld computing device, a mobile phone, a laptop computer, a work station, and/or a network of computing devices. As illustrated in FIG. 6A (and in more detail in FIG. 6B) user systems 620 might interact via a network 618 with an on-demand database service, which is system 602.

An on-demand database service, such as system 602, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 602” and “system 602” is used interchangeably herein. A database image may include one or more database objects. A relational database management system (RDMS) or the equivalent may execute storage and retrieval of information against the database object(s). Application platform 610 may be a framework that allows the applications of system 602 to run, such as the hardware and/or software, e.g., the operating system. In an embodiment, on-demand database service 602 may include an application platform 610 that enables creation, managing and executing one or more applications developed by the provider of the on-demand database service, users accessing the on-demand database service via user systems 620, or third party application developers accessing the on-demand database service via user systems 620.

The users of user systems 620 may differ in their respective capacities, and the capacity of a user system 620 might be entirely determined by permissions (permission levels) for the current user. For example, where a salesperson is using a user system 620 to interact with system 602, that user system has the capacities allotted to that salesperson. However, while an administrator is using that user system to interact with system 602, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities when accessing and modifying application and database information, depending on a user's security or permission level.

Network 618 is any network or combination of networks of devices that communicate with one another. For example, network 618 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it is understood that the networks that the claimed embodiments may utilize are not so limited, although TCP/IP is a frequently implemented protocol.

User systems 620 might communicate with system 602 using TCP/IP and, at a higher network level, use other common Internet protocols to communicate, such as HTTP, FTP, AFS, WAP, etc. In an example where HTTP is used, user system 620 might include an HTTP client commonly referred to as a “browser” for sending and receiving HTTP messages to and from an HTTP server at system 602. Such an HTTP server might be implemented as the sole network interface between system 602 and network 618, but other techniques might be used as well or instead. In some implementations, the interface between system 602 and network 618 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 602, shown in FIG. 6A, implements a web-based customer relationship management (CRM) system. For example, in one embodiment, system 602 includes application servers configured to implement and execute CRM software applications as well as provide related data, code, forms, webpages and other information to and from user systems 620 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 602 implements applications other than, or in addition to, a CRM application. For example, system 602 may provide tenant access to multiple hosted (standard and custom) applications, including a CRM application. User (or third-party developer) applications, which may or may not include CRM, may be supported by the application platform 610, which manages creation, storage of the applications into one or more database objects and executing of the applications in a virtual machine in the process space of the system 602.

One arrangement for elements of system 602 is shown in FIG. 6A, including a network interface 616, application platform 610, tenant data storage 604 for tenant data 605, system data storage 606 for system data 607 accessible to system 602 and possibly multiple tenants, program code 608 for implementing various functions of system 602, and a process space 614 for executing MTS system processes and tenant-specific processes, such as running applications as part of an application hosting service. Additional processes that may execute on system 602 include database indexing processes.

Several elements in the system shown in FIG. 6A include conventional, well-known elements that are explained only briefly here. For example, each user system 620 may include a desktop personal computer, workstation, laptop, PDA, cell phone, or any wireless access protocol (WAP) enabled device or any other computing device capable of interfacing directly or indirectly to the Internet or other network connection. User system 620 typically runs an HTTP client, e.g., a browsing program, such as Microsoft's Internet Explorer browser, a Mozilla or Firefox browser, an Opera, or a WAP-enabled browser in the case of a smartphone, tablet, PDA or other wireless device, or the like, allowing a user (e.g., subscriber of the multi-tenant database system) of user system 620 to access, process and view information, pages and applications available to it from system 602 over network 618. Each user system 620 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 602 or other systems or servers. For example, the user interface device can be used to access data and applications hosted by system 602, and to perform searches on stored data, and otherwise allow a user to interact with various GUI pages that may be presented to a user. As discussed above, embodiments are suitable for use with the Internet, which refers to a specific global internetwork of networks. However, it is understood that other networks can be used instead of the Internet, such as an intranet, an extranet, a virtual private network (VPN), a non-TCP/IP based network, any LAN or WAN or the like.

According to one embodiment, each user system 620 and all its components are operator configurable using applications, such as a browser, including computer code run using a central processing unit such as an Intel Pentium® processor or the like. Similarly, system 602 (and additional instances of an MTS, where more than one is present) and all of their components might be operator configurable using application(s) including computer code to run using a central processing unit such as processor system 612, which may include an Intel Pentium® processor or the like, and/or multiple processor units.

According to one embodiment, each system 602 is configured to provide webpages, forms, applications, data and media content to user (client) systems 620 to support the access by user systems 620 as tenants of system 602. As such, system 602 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS may include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It is understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6B illustrates another block diagram of an embodiment of elements of FIG. 6A and various possible interconnections between such elements in accordance with the described embodiments. FIG. 6B also illustrates environment 601. However, in FIG. 6B, the elements of system 602 and various interconnections in an embodiment are illustrated in further detail. More particularly, FIG. 6B shows that user system 620 may include a processor system 638, memory system 640, input system 642, and output system 644. FIG. 6B shows network 618 and system 602. FIG. 6B also shows that system 602 may include tenant data storage 604, having therein tenant data 605, which includes, for example, tenant storage space 605_1, tenant data 605_2, and application metadata 605_3. System data storage 606 is depicted as having therein system data 607. Further depicted within the expanded detail of application servers 622_1-N are User Interface (UI) 636, Application Program Interface (API) 634, application platform 610 includes PL/SOQL 628, save routines 626, application setup mechanism 624, process space 614 includes system process space 632, tenant 1-N process spaces 630_1, and tenant management process space 630. In other embodiments, environment 601 may not have the same elements as those listed above and/or may have other elements instead of, or in addition to, those listed above.

User system 620, network 618, system 602, tenant data storage 604, and system data storage 606 were discussed above in FIG. 6A. As shown by FIG. 6B, system 602 may include a network interface 616 (of FIG. 6A) implemented as a set of HTTP application servers 622, an application platform 610, tenant data storage 604, and system data storage 606. Also shown is system process space 632, including individual tenant process spaces 630_1 and a tenant management process space 630. Each application server 622 may be configured to tenant data storage 604 and the tenant data 605 therein, and system data storage 606 and the system data 607 therein to serve requests of user systems 620. The tenant data 605 might be divided into individual tenant storage areas (e.g., tenant storage space 605_1), which can be either a physical arrangement and/or a logical arrangement of data. Within each tenant storage space 605_1, tenant data 605_2, and application metadata 605_3 might be similarly allocated for each user. For example, a copy of a user's most recently used (MRU) items might be stored to tenant data 605_2. Similarly, a copy of MRU items for an entire organization that is a tenant might be stored to tenant storage space 605_1. A UI 636 provides a user interface and an API 634 provides an application programmer interface into system 602 resident processes to users and/or developers at user systems 620. The tenant data and the system data may be stored in various databases, such as one or more Oracle™ databases.

Application platform 610 includes an application setup mechanism 624 that supports application developers' creation and management of applications, which may be saved as metadata into tenant data storage 604 by save routines 626 for execution by subscribers as one or more tenant process spaces 630_1 managed by tenant management process space 630 for example. Invocations to such applications may be coded using PL/SOQL 628 that provides a programming language style interface extension to API 634. Invocations to applications may be detected by one or more system processes, which manage retrieving application metadata 605_3 for the subscriber making the invocation and executing the metadata as an application in a virtual machine.

Each application server 622 may be communicably coupled to database systems, e.g., having access to system data 607 and tenant data 605, via a different network connection. For example, one application server 622i might be coupled via the network 618 (e.g., the Internet), another application server 622N-1 might be coupled via a direct network link, and another application server 622N might be coupled by yet a different network connection. Transfer Control Protocol and Internet Protocol (TCP/IP) are typical protocols for communicating between application servers 622 and the database system. However, it will be apparent to one skilled in the art that other transport protocols may be used to optimize the system depending on the network interconnect used.

In certain embodiments, each application server 622 is configured to handle requests for any user associated with any organization that is a tenant. Because it is desirable to be able to add and remove application servers from the server pool at any time for any reason, there is preferably no server affinity for a user and/or organization to a specific application server 622. In one embodiment, therefore, an interface system implementing a load balancing function (e.g., an F5 Big-IP load balancer) is communicably coupled between the application servers 622 and the user systems 620 to distribute requests to the application servers 622. In one embodiment, the load balancer uses a least connections algorithm to route user requests to the application servers 622. Other examples of load balancing algorithms, such as round robin and observed response time, also can be used. For example, in certain embodiments, three consecutive requests from the same user may hit three different application servers 622, and three requests from different users may hit the same application server 622. In this manner, system 602 is multi-tenant, in which system 602 handles storage of, and access to, different objects, data and applications across disparate users and organizations.

As an example of storage, one tenant might be a company that employs a sales force where each salesperson uses system 602 to manage their sales process. Thus, a user might maintain contact data, leads data, customer follow-up data, performance data, goals and progress data, etc., all applicable to that user's personal sales process (e.g., in tenant data storage 604). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all the users for a given organization that is a tenant. Thus, there might be some data structures managed by system 602 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 602 might also maintain system level data usable by multiple tenants or other data. Such system level data might include industry reports, news, postings, and the like that are sharable among tenants.

In certain embodiments, user systems 620 (which may be client systems) communicate with application servers 622 to request and update system-level and tenant-level data from system 602 that may require sending one or more queries to tenant data storage 604 and/or system data storage 606. System 602 (e.g., an application server 622 in system 602) automatically generates one or more SQL statements (e.g., one or more SQL queries) that are designed to access the desired information. System data storage 606 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

The term “user” may refer to a system user, such as, but not limited to, a software/application developer, a system administrator, a database administrator, an information technology professional, a program manager, product manager, etc. The term “user” may also refer to an end-user, such as, but not limited to, an organization (e.g., a business, a company, a corporation, a non-profit entity, an institution, an agency, etc.) serving as a customer or client of the provider (e.g., Salesforce.com®) of a user device (such as user system 620 in FIGS. 6A-6B) or an organization's representative, such as a salesperson, a sales manager, a product manager, an accountant, a director, an owner, a president, a system administrator, a computer programmer, an information technology (“IT”) representative, etc.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com, Salesforce 1®, Apex™ code, JavaScript™, jQuery™, Developerforce™, Visualforce™, Service Cloud Console Integration Toolkit™ (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

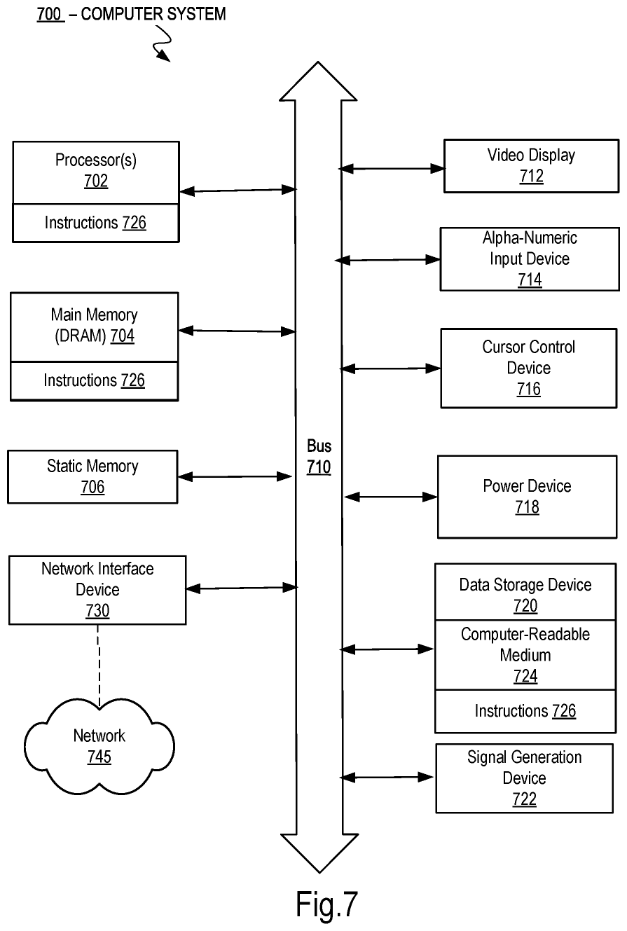

FIG. 7 illustrates a diagrammatic representation of a machine in the exemplary form of a computer system 700 within which a set of instructions (e.g., for causing the machine to perform any one or more of the methodologies discussed herein) may be executed. In alternative implementations, the machine may be connected (e.g., networked) to other machines in a LAN, a WAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a PDA, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 700 may be utilized by or illustrative of any of the electronic components described herein (e.g., any of the components illustrated in or described with respect to FIGS. 1, 2, 3 and 6A-6B).

The exemplary computer system 700 includes a processing device (processor) 702, a main memory 704 (e.g., ROM, flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 720, which communicate with each other via a bus 710.

Processor 702 represents one or more general-purpose processing devices such as a microprocessor, central processing unit, or the like. More particularly, processor 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute instructions 726 for performing the operations and steps discussed herein. Processor 702 may have one or more processing cores.

Computer system 700 may further include a network interface device 708. Computer system 700 also may include a video display unit 712 (e.g., a liquid crystal display (LCD), a cathode ray tube (CRT), or a touch screen), an alphanumeric input device 714 (e.g., a keyboard), a cursor control device 716 (e.g., a mouse or touch screen), and a signal generation device 722 (e.g., a loud speaker).

Power device 718 may monitor a power level of a battery used to power computer system 700 or one or more of its components. Power device 718 may provide one or more interfaces to provide an indication of a power level, a time window remaining prior to shutdown of computer system 700 or one or more of its components, a power consumption rate, an indicator of whether computer system is utilizing an external power source or battery power, and other power related information. In some implementations, indications related to power device 718 may be accessible remotely (e.g., accessible to a remote back-up management module via a network connection). In some implementations, a battery utilized by power device 718 may be an uninterruptable power supply (UPS) local to or remote from computer system 700. In such implementations, power device 718 may provide information about a power level of the UPS.

Data storage device 720 may include a computer-readable storage medium 724 (e.g., a non-transitory computer-readable storage medium) on which is stored one or more sets of instructions 726 (e.g., software) embodying any one or more of the methodologies or functions described herein. Instructions 726 may also reside, completely or at least partially, within main memory 704 and/or within processor 702 during execution thereof by computer system 700, main memory 704, and processor 702 also constituting computer-readable storage media. Instructions 726 may further be transmitted or received over a network 745 via network interface device 730.

In one implementation, instructions 726 include instructions for performing any of the implementations described herein. While computer-readable storage medium 724 is shown in an exemplary implementation to be a single medium, it is to be understood that computer-readable storage medium 724 may include a single medium or multiple media (e.g., a centralized or distributed database, and/or associated caches and servers) that store the one or more sets of instructions.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims is to be accorded the broadest interpretation to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

1. A computer-implemented method for authenticating a transaction initiated with a voice-enabled device comprising:
receiving a request on a customer device to initiate a transaction with a vendor, the customer device enabled to respond to a user's voice;
determining that a customer profile based on a first and second authentication factors is associated with the customer device, wherein determining confirms the first authentication factor, and further wherein the second authentication factor represents a voice signature of the user's voice;
generating the transaction encoded with the customer profile to authenticate the transaction, the customer profile associated with the customer device;
transmitting the transaction from the customer device to a vendor device operated by the vendor;
receiving a confirmation request on the customer device from a voice transaction gateway in communication with the vendor device to confirm the second authentication factor;
capturing a voice imprint of the customer responsive to receiving the confirmation request; and
matching the voice imprint of the customer to the voice signature in the customer profile to confirm the second authentication factor.

2. The computer-implemented method of claim 1, further comprising:
receiving on the customer device a notification from the voice transaction gateway that an authenticated transaction is any one of authorized or not authorized by a gateway integrated with the voice transaction gateway.

3. The computer-implemented method of claim 1, wherein determining that the customer profile is associated with the customer device includes:
receiving private information from the customer; and
verifying the private information matches corresponding information in the customer profile, the private information including any one or more of a password, a personal identification number and a unique biometric, the unique biometric including the voice imprint.

4. The computer-implemented method of claim 3 wherein capturing the voice imprint responsive to receiving the confirmation request includes:
preventing the vendor to whom the transaction was transmitted from receiving the private information of the customer, including preventing the vendor from receiving communications capturing the voice imprint of the customer, to protect against exposure of the private information of the customer to the vendor; and
transmitting the voice imprint used to confirm the second authentication factor to the voice transaction gateway to authenticate the transaction based on the first and second authentication factors, wherein the voice transaction gateway can verify matching the voice imprint of the customer to the voice signature in the customer profile.

5. The computer-implemented method of claim 4, wherein capturing the voice imprint includes:
capturing a voice sentiment of the customer responsive to receiving the confirmation request, the voice sentiment captured at least in part as part of or in addition to the voice imprint; and
determining that the voice sentiment indicates any one of disapproving the transaction and approving the transaction.

6. The computer-implemented method of claim 4, further comprising:
wherein the customer profile includes a customer phone number (“customer PH #) registered to any of a primary customer and a secondary customer associated with the customer profile, the request of the secondary customer subject to authentication by the primary customer;
determining that the customer that initiated the request is the secondary customer associated with the profile;
transmitting the confirmation request to the primary customer associated with the customer profile, including calling the customer PH # registered to the primary customer to confirm the first authentication factor; and
capturing the voice imprint of the primary customer answering an incoming call to the customer PH #, wherein matching the voice imprint of the primary customer to the voice signature in the customer profile confirms the second authentication factor.

7. The computer-implemented method of claim 6, wherein transmitting the transaction to the vendor includes anonymizing a customer who initiated the transaction on the customer device.

8. The computer-implemented method of claim 7, wherein anonymizing the customer who initiated the transaction on the customer device includes:
assigning a random phone number (“random PH #”) for transmitting the transaction to the vendor;
mapping to the random PH # the customer PH # of the customer device on which the request to initiate the transaction was received; and
transmitting the transaction from the customer device to the vendor device as originating from the random PH # without disclosing the customer PH # of the customer device.

9. The computer-implemented method of claim 8, wherein receiving the confirmation request from the voice transaction gateway includes receiving an incoming call to the customer PH # of the customer device, the voice transaction gateway having extracted the customer PH # from the mapping to the random PH #.

10. The computer-implemented method of claim 2, wherein:
the transaction is a financial transaction; and
receiving the notification from the voice transaction gateway that the authenticated transaction is any one of authorized or not authorized includes receiving an indication of an amount authorized or not authorized for the transaction, the amount provided by the vendor.

11-16. (canceled)

17. A tangible, non-transitory computer-readable storage medium having instructions encoded thereon which, when executed by a processing device, cause the processing device to:
receive a request from a customer to initiate a transaction with a vendor, the processing device enabled to respond to the customer's voice;
determine that a customer profile based on a first and second authentication factors is associated with the processing device, wherein to determine includes to confirm the first authentication factor, and further wherein the second authentication factor represents a voice signature of the user's voice;
generate the transaction encoded with the customer profile to authenticate the transaction, the customer profile associated with the processing device;
transmit the transaction from the processing device to a vendor device operated by the vendor;
receive a confirmation request on the processing device from a voice transaction gateway in communication with the vendor device to confirm the second authentication factor;
capture a voice imprint of the customer responsive to receiving the confirmation request; and
match the voice imprint of the customer to the voice signature in the customer profile to confirm the second authentication factor.

18. The tangible, non-transitory computer-readable storage medium of claim 17, wherein the instructions cause the processing device to further:
receive a notification from the voice transaction gateway that an authenticated transaction is any one of authorized or not authorized by a gateway integrated with the voice transaction gateway.

19. The tangible, non-transitory computer-readable storage medium of claim 17, wherein, to determine that the customer profile is associated with the processing device, the instructions cause the processing device to further:
receive private information from the customer; and
verify the private information matches corresponding information in the customer profile, the private information including any one or more of a password, a personal identification number and a unique biometric, the unique biometric including the voice imprint.

20. The tangible, non-transitory computer-readable storage medium of claim 19 wherein the instructions to capture the voice imprint responsive to confirmation request cause the processing device to further:
prevent the vendor to whom the transaction was transmitted from receiving the private information of the customer, including to prevent the vendor from receiving communications to capture the voice imprint of the customer, to protect against exposure of the private information of the customer to the vendor; and
transmit the voice imprint used to confirm the second authentication factor to the voice transaction gateway to authenticate the transaction based on the first and second authentication factors, wherein the voice transaction gateway can verify a match of the voice imprint of the customer to the voice signature in the customer profile.

21. The tangible, non-transitory computer-readable storage medium of claim 20, wherein the instructions to capture the voice imprint cause the processing device to further:
capture a voice sentiment of the customer responsive to receiving the conformation request, the voice sentiment captured at least in part as part of or in addition to the the voice imprint; and
determine that the voice sentiment indicates the customer intends to any one of disapprove the transaction and approve the transaction.

22. The tangible, non-transitory computer-readable storage medium of claim 20, wherein:
the customer profile includes a customer phone (“customer PH #”) registered to any of a primary customer and a secondary customer associated with the customer profile, the request of the secondary customer subject to authentication by the primary customer; and
the instructions cause the processing device to further:
determine that the customer that initiated the request is the secondary customer associated with the customer profile,
transmit the confirmation request to the primary customer associated with the customer profile, including calling the customer PH # registered to the primary customer to confirm the first authentication factor, and
capture the voice imprint of the primary customer answering an incoming call to the customer PH #, wherein to match the voice imprint of the primary customer to the voice signature in the customer profile confirms the second authentication factor.

23. The tangible, non-transitory computer-readable storage medium of claim 22, wherein the instructions to transmit the transaction to the vendor cause the processing device to anonymize a customer who initiated the transaction on the processing device, including to:
assign a random phone number (“random PH #”) for transmitting the transaction to the vendor;
map to the random PH # the customer PH # of the processing device on which the request to initiate the transaction was received; and
transmit the transaction from the processing device to the vendor as originating from the random PH # without disclosing the customer PH # of the processing device.

24. The tangible, non-transitory computer-readable storage medium of claim 23, wherein the instructions to receive the confirmation request from the voice transaction gateway cause the processing device to receive an incoming call to the customer PH # of the processing device, the incoming call having been initiated by the voice transaction gateway after extracting the customer PH # from the map to the random PH #.

25. The tangible, non-transitory computer-readable storage medium of claim 18, wherein the transaction is a financial transaction and the instructions cause the processing device to further receive the notification from the voice transaction gateway that the authenticated transaction is any one of authorized or not authorized, the notification including an indication of an amount authorized or not authorized for the transaction, the amount provided by the vendor.
